(19) United States
(12) Patent Application Publication
(10) Pub. No.: US 2022/0051298 A1
(43) Pub. Date: Feb. 17, 2022

(54) Systems and Methods for a Campaign Design Platform

(71) Applicant: Selligent, S.A., Braine-l' Alleud (BE)

(72) Inventor: Pieter RASKIN, Braine-l' Alleud (BE)

(21) Appl. No.: 17/334,020

(22) Filed: May 28, 2021

Related U.S. Application Data
(60) Provisional application No. 63/064,315, filed on Aug. 11, 2020.

(51) Int. Cl. G06Q 30/02; G06F 3/0486

(52) U.S. Cl. CPC G06Q 30/0276; G06F 3/0486; G06Q 30/0277

(57) ABSTRACT

A marketing campaign design system includes a graphical user interface that enables a user to define a custom event with respect to an audience. The custom event associates the audience with incoming custom event data. The system also includes a journey design module that enables the user to design a marketing campaign or portion thereof via drag-and-drop of one or more journey components. The journey components represent actions to be taken by a computerized marketing system in executing the marketing campaign or portion thereof. The graphical user interface also enables the user to link a marketing campaign or portion thereof to the audience, so as to activate one or more custom journey components, usable by the user to design the marketing campaign, the custom journey components referencing the custom event data.

### CROSS-REFERENCE TO RELATED APPLICATIONS

This application claims priority to U.S. Appl. No. 63/064,315, filed Aug. 11, 2020, the entire contents of which are hereby expressly incorporated by reference herein.

This application is also related to U.S. application Ser. No. 17/238,974, filed Apr. 23, 2021, the entire contents of which are hereby expressly incorporated by reference herein.

### BACKGROUND AND SUMMARY OF THE INVENTION

The present invention relates to computer and internet technology, namely, systems and methods for providing a campaign design platform that facilitates user creation of custom events for utilization in designing campaigns and portions thereof.

In particular, aspects of marketing campaign design systems and methods are disclosed, via which a user can utilize a campaign design platform to design marketing campaigns, or aspects thereof, for implementation by a computerized marketing system. The systems and methods enable a user, via a graphical user interface, to design a marketing campaign, or portion thereof, via drag-and-drop of one or more journey components. The journey components represent actions to be taken by the computerized marketing system in executing the marketing campaign. The user is also enabled to define a custom event with respect to an audience, wherein the custom event associates the audience with incoming custom event data, and to link the marketing campaign and the audience, so as to activate one or more custom journey components that reference the custom event data. The custom journey components are then usable to design the marketing campaigns for execution by the computerized marketing system.

Additional aspects of the marketing campaign design systems and methods enable the user to design an electronic message via drag-and-drop of one or more message components that represent software code to be included in the electronic message affecting the display of the electronic message to its recipient. The user is also enabled to link the electronic message to the audience, so as to activate the use of custom event data within the one or more message components.

Other objects, advantages and novel features of the present invention will become apparent from the following detailed description of one or more preferred embodiments when considered in conjunction with the accompanying drawings. It should be recognized that the one or more examples in the disclosure are non-limiting examples and that the present invention is intended to encompass variations and equivalents of these examples.

### BRIEF DESCRIPTION OF THE DRAWINGS

The features, objects, and advantages of the present invention will become more apparent from the detailed description, set forth below, when taken in conjunction with the drawings, in which like reference characters identify elements correspondingly throughout.

FIG. 1A illustrates a system and system architecture in accordance with at least one embodiment of the invention.

FIG. 1B illustrates an exemplary event data object in accordance with at least one embodiment of the invention.

FIGS. 2-12 illustrate aspects of an exemplary graphical-user-interface in accordance with at least one embodiment of the invention.

### DETAILED DESCRIPTION OF THE PREFERRED EMBODIMENTS

The above described drawing figures illustrate the present invention in at least one embodiment, which is further defined in detail in the following description. Those having ordinary skill in the art may be able to make alterations and modifications to what is described herein without departing from its spirit and scope. While the present invention is susceptible of embodiment in many different forms, there is shown in the drawings and will herein be described in detail at least one preferred embodiment of the invention with the understanding that the present disclosure is to be considered as an exemplification of the principles of the present invention, and is not intended to limit the broad aspects of the present invention to any embodiment illustrated.

In accordance with the practices of persons skilled in the art, the invention is described below with reference to operations that are performed by a computer system or a like electronic system. Such operations are sometimes referred to as being computer-executed. It will be appreciated that operations that are symbolically represented include the manipulation by a processor, such as a central processing unit, of electrical signals representing data bits and the maintenance of data bits at memory locations, such as in system memory, as well as other processing of signals. The memory locations where data bits are maintained are physical locations that have particular electrical, magnetic, optical, or organic properties corresponding to the data bits.

When implemented in software, code segments perform certain tasks described herein. The code segments can be stored in a processor readable medium. Examples of the processor readable mediums include an electronic circuit, a semiconductor memory device, a read-only memory (ROM), a flash memory or other non-volatile memory, a floppy diskette, a CD-ROM, an optical disk, a hard disk, etc.

In the following detailed description and corresponding figures, numerous specific details are set forth in order to provide a thorough understanding of the present invention. However, it should be appreciated that the invention may be practiced without such specific details. Additionally, well-known methods, procedures, components, and circuits have not been described in detail.

The present invention generally relates to a campaign design platform via which a user can design campaigns, or aspects thereof, for implementation by a computerized marketing system.

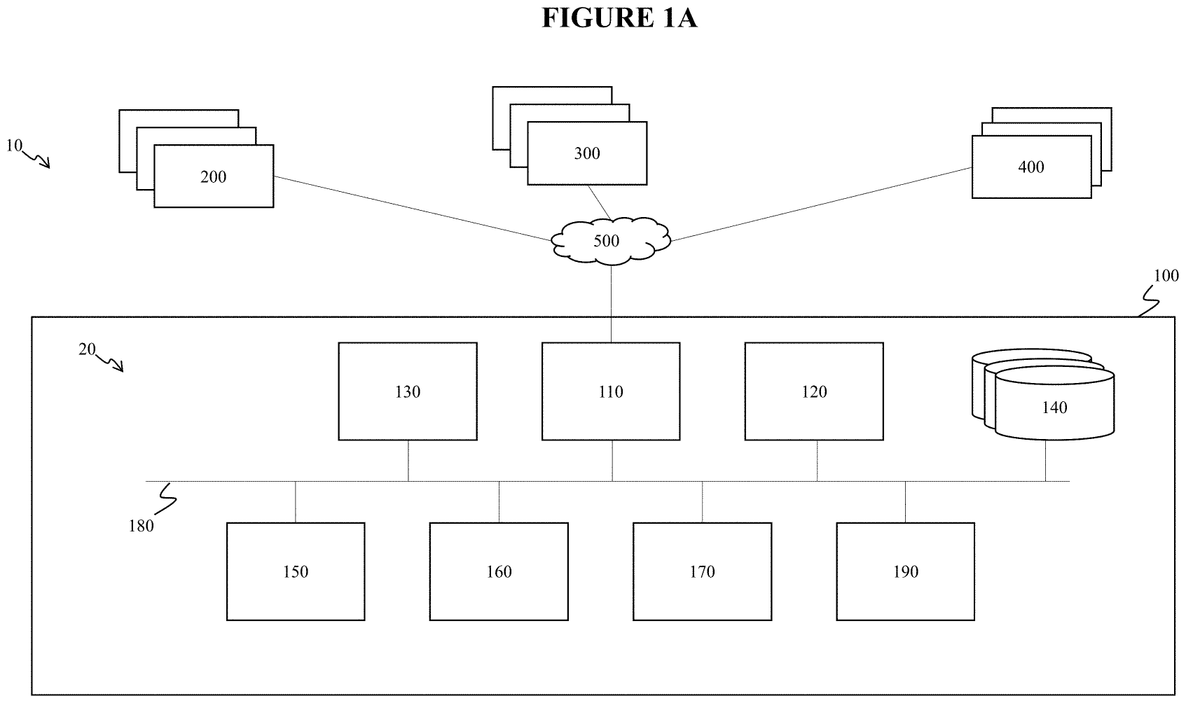

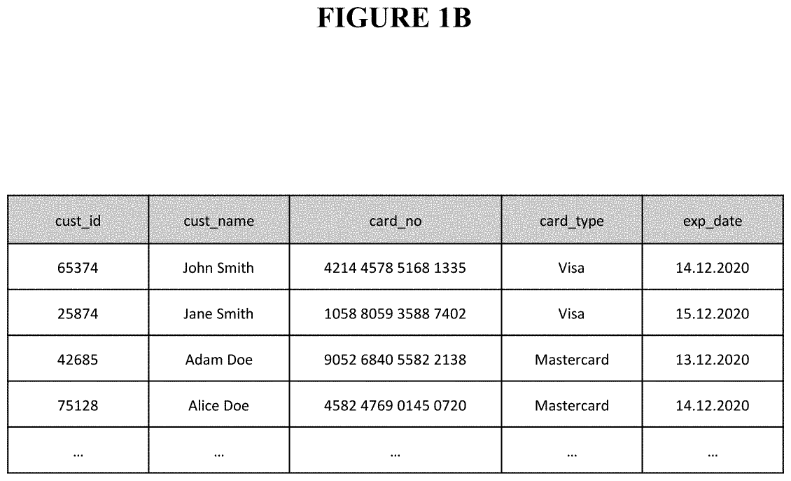

FIG. 1A illustrates an exemplary system 10 in accordance with one or more aspects of the invention. In general, the system 10 provides the campaign design platform via which the user can design campaigns, or aspects thereof, for implementation by the computerized marketing system 10. As used herein, the term “campaign” refers to a set of operations or actions effectuated by the marketing system 10, as well as the interaction between such operations or actions and with external stimuli (e.g., externally provided data representing consumer action). As such, the operations or actions may be represented by a series of instructions for execution by the marketing system 10. The term “campaign” is also used herein to refer what would commonly be understood as the entire campaign (e.g., an e-mail marketing strategy), as well as sets of operations that are not the entire campaign (e.g., an e-mail design).

The system 10 generally comprises a server system 100 coupled to one or more third-party computer systems 200, one or more customer devices 300 and one or more user devices 400, via a network 500.

The server system 100 generally supports the campaign design platform described herein, and may further support the marketing system 10. The server system 100 may include one or more server system computers connected to the network 500. Each server system computer may include computer components, including one or more processors, memories, displays and interfaces, and may also include software instructions and data for executing the functions of the server system 100 described herein. The server system 100 may also include one or more storage devices configured to store large quantities of data and/or information, and may further include one or more databases. For example, the storage device may be a collection of storage components, or a mixed collection of storage components, such as ROM, RAM, hard-drives, solid-state drives, removable drives, network storage, virtual memory, cache, registers, etc. The storage device may also be configured so that the server system computers may access it.

The third-party computer systems 200 may be supported by third-party servers, and may generally support third-party services and/or platforms, such as for example, websites, databases, online services, communication platforms, and the like, which may be utilized by the marketing system in the execution of one or more campaigns. The third-party computer systems 200 may include one or more third-party computers connected to the network 500. Each third-party computer may include computer components, such as one or more processors, memories, displays and interfaces, and may also include software instructions and data for executing the functions of the third-party computer system 200. The third-party computer systems 200 may also include one or more storage devices configured to store large quantities of data and/or information, and may further include one or more databases. For example, the storage device may be a collection of storage components, or a mixed collection of storage components, such as ROM, RAM, hard-drives, solid-state drives, removable drives, network storage, virtual memory, cache, registers, etc. The storage device may also be configured so that the third-party computers may access it.

The third-party computer systems 200, including components, services, databases, software and platforms thereof, may be accessible to the server system via one or more application programming interfaces (APIs). The APIs may be provided by respective third-party computer systems, and may be used by the server system in accessing the third-party computer systems.

The user devices 400 generally provide a user with the ability to access and otherwise interact with the campaign design platform, and may further provide the user with the ability to access and otherwise interact with the marketing system 10. Such user interaction may be via a graphical user interface, as is generally known in the art. The user devices 400 are generally computing devices, which may be mobile (e.g., laptop computers, tablet computers, smartphones, PDAs, wearables, etc.) or stationary (e.g., desktop computers, etc.) devices connected to the network. The user devices 400 may include computer components, such as one or more processors, memories, displays and interfaces, and may also include software instructions and data for executing the functions of the user devices.

The processors may instruct the computer components to perform various tasks based on the processing of information and/or data that may have been previously stored or have been received, such as software instructions and/or data stored in the memory(s). The processors may be standard processors, such as a central processing unit (CPU), or may be dedicated processors, such as an application-specific integrated circuit (ASIC) or a field programmable gate array (FPGA), or a graphical processing unit (GPU).

The memories may store at least software instructions and/or data that can be accessed by the processors. For example, the memories may be hardware capable of storing information accessible by the processors, such as a ROM, RAM, hard-drive, CD-ROM, DVD, write-capable, read-only, etc. The set of instructions may be included in software that can be implemented on the computers. It should be noted that the terms “instructions,” “steps,” “algorithm,” and “programs” may be used interchangeably. The data can be retrieved, manipulated or stored by the processors in accordance with the software instructions or other sets of executable instructions. The data may be stored as a collection of data. Accordingly, the computers may include one or more respective software applications, stored in respective memories, which software applications, when executed by the processors configures the computers to execute the various functions described herein

The displays may be any type of device capable of visually communicating data, such as a liquid-crystal display (“LCD”) screen, a plasma screen, etc. The interfaces allow users to communicate with the computers and may be a physical device (e.g., a port, a keyboard, a mouse, a touch-sensitive screen, microphone, camera, a universal serial bus (USB), CD/DVD drive, zip drive, card reader, etc.) and/or may be virtual (e.g., a graphical user interface “GUI,” etc.).

The consumer devices generally provide a consumer with the ability to send/receive data in accordance with the execution of the marketing campaign. For example, the consumer devices may be configured to receive electronic messages (e.g., e-mail, SMS, text message, etc.) from the marketing system 10—and may further be configured to provide data, which may be accessible by the campaign design platform, via interaction with the third-party computer systems 200 (e.g., an online sale, browsing the third-party website, QR code reading, etc.). The consumer devices are generally computing devices, which may be mobile (e.g., laptop computers, tablet computers, smartphones, PDAs, wearables, etc.) or stationary (e.g., desktop computers, etc.) devices connected to the network. The consumer devices may include computer components, such as one or more processors, memories, displays and interfaces, and may also include software instructions and data for executing the functions of the consumer devices, these computer components being generally similar to those of the user devices 400 discussed herein.

The network 500 may be any type of network, wired or wireless, configured to facilitate the communication and transmission of data, instructions, etc. from one component to another component of the network. For example, the network 500 may be a local area network (LAN) (e.g., Ethernet or other IEEE 802.03 LAN technologies), Wi-Fi (e.g., IEEE 802.11 standards, wide area network (WAN), virtual private network (VPN), global area network (GAN)), any combination thereof, or any other type of network.

It is to be understood that the configuration illustrated in FIG. 1A serves only as an example and is thus not limited thereto. The system 10, for instance, may include numerous other components, or more than one of each component, connected to network, and the network may be connected to other networks. As discussed, the system 10 may be implemented via computer executed software, appropriately programmed hardware, or any combination thereof. As such, the various functionalities of the system may be understood in terms of computer executed software modules in accordance with a system architecture 20.

FIG. 1A further illustrates an exemplary system architecture 20 in accordance with at least one aspect of the invention. In general, the system architecture 20 is embodied in the system, and may include one or more functional modules and/or systems for implementing the campaign design platform, including but not limited to: an network interface module 110, a GUI module 120, a build module 130, one or more databases 140, an audience module 150, a journey design module 160, a message design module 170, communicatively connected via a platform network 180.

The network interface module 110 enables and manages data communication between the server system 100, or components thereof, and other components of the system via the network 500. For example, the network interface module 110 may enable and manage data communication via local area network (LAN) (e.g., Ethernet or other IEEE 802.03 LAN technologies), Wi-Fi (e.g., IEEE 802.11 standards, wide area network (WAN), virtual private network (VPN), global area network (GAN)), any combination thereof, or any other type of network.

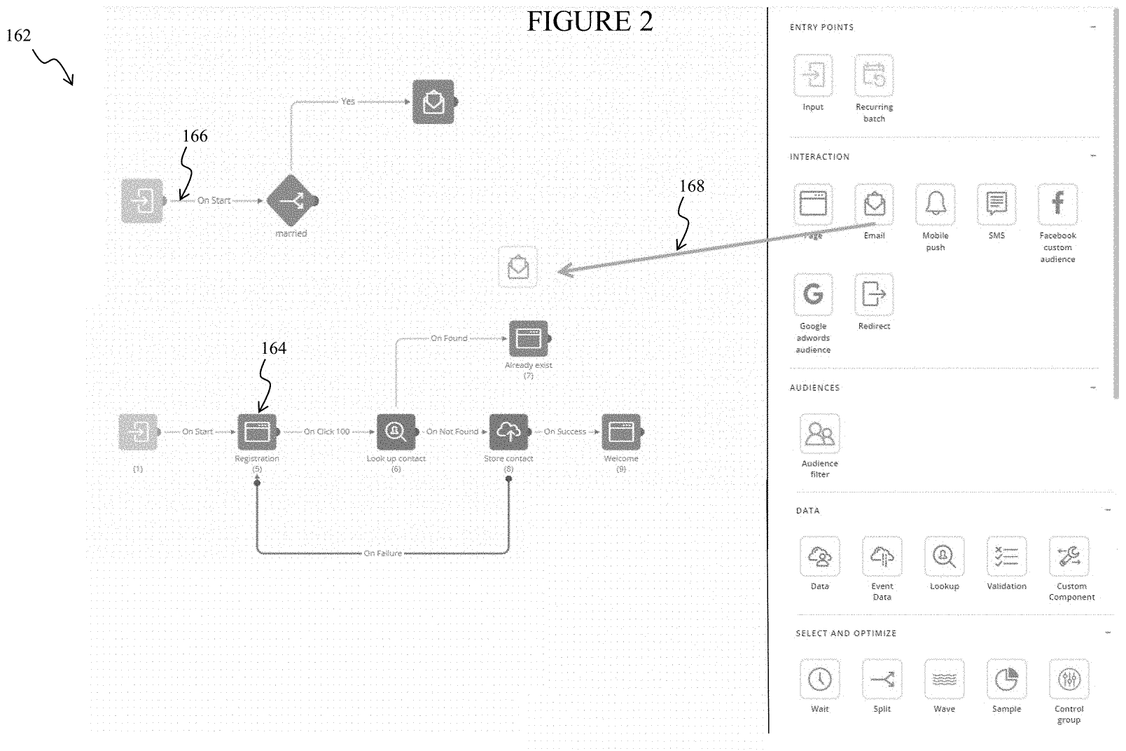

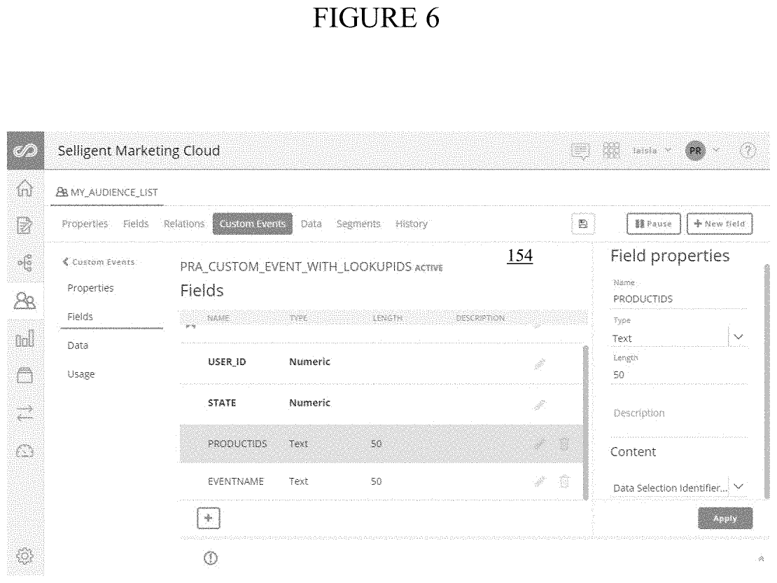

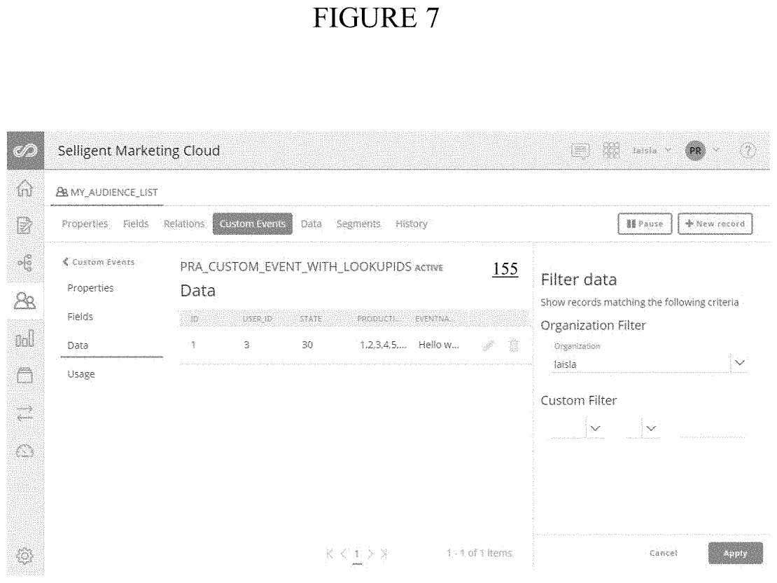

The GUI module 120 enables and manages the graphical-user-interface via which the user interacts with the campaign design platform, including the various other components (e.g., the various modules) through which the functions of the campaign design platform may be implemented. The graphical-user-interface generally includes one or more graphic elements, such as windows, drop-down menus, buttons, fields, etc., and enables direct manipulation of the graphic elements by the user via the user computer. The graphical-user-interface converts user interaction with the graphic elements into instructions that are communicated to other components of the system architecture 20, converts aspects of such other components into the graphic elements, and communications the graphical-user-interface to the user computer via the network for display thereon. Various aspects of the graphical-user-interface will be described further herein with reference to FIGS. 2-12.

The journey design module 160 generally enables and manages the design of campaign journeys, which reflect portions of the campaign, by the user, which journeys may be implemented by the computerized marketing system 10. The journey design module 160 may cause the GUI module 120 to generate and display the graphical-user-interface to include a virtual canvas 162 via which one or more journeys may be designed by the user.

FIG. 2 schematically illustrates an example virtual canvas via which one or more journeys (e.g., the entire campaign or parts of it) may be designed by the user.

The virtual canvas 162 is an interactive graphical-user-interface environment via which the user may plan and define journeys through direct user interaction 168 (e.g., via drag-and-drop, etc.) with graphic elements representing various journey components 164. Each journey component is software code that represents a specific action or actions to be taken by the computerized marketing system 10. A set of journey components 164 reflects a set of actions that defines the journey, or aspects thereof.

Each journey component may also have one or more associated triggers 166. The triggers represent actions or events, which when satisfied, progress the implementation of the journey by the computerized marketing system 10 from component to component. Accordingly, the one or more journey components 164 and associated triggers 166 may be utilized by the user to design the journey, or aspects thereof, via the journey design module 160.

It will be understood that the term “event” is used interchangeably herein to refer to an event in the real world, e.g., the expiration of a credit card, as well as to incoming data to the system representing the event, i.e., event data, where the former is a convenient conceptual tool for the latter. Each event may be defmed by an event data object 30, which may be stored in the database 140. As shown in FIG. 1B, for example, the event data objects 30 may be, for example, data records that associate an audience set with event data. As such the event data object 30 may include an audience field 32 and one or more event data fields 34. The audience field 32 reflects the audience set to whom the event pertains, and includes customers, message recipients, individuals, and/or proxies thereof (e.g., email accounts, customer numbers, etc.). The event data fields 34 reflect event data related to the event, and define the type of incoming event data that will be recorded by each respective event data field 34. It will be understood that the event data can be of any type, such as, for example, text, Boolean, numeric, long, float, date, datetime, complex data, etc., and any combination thereof. In the example of FIG. 1B, the event is the expiration of a credit card, with fields for cuss name, card_no, card_type and exp_date, reflecting that the fields are to be respectively populated with event data (for the respective audience member) reflecting customer names, card numbers, card types and expiration dates.

An event management module (not shown) may be configured to write, update, delete and otherwise manage the event data entries within each field. In at least one embodiment, the event data entries are maintained in response to the incoming event data so as to be substantially up to date as events occur in real time. In operation, incoming event data may be associated with one or more events, event data objects and/or event fields, which association the event management module may reference to manage the event data entries of the event data object 30.

As discussed further herein, the event data objects 30 may be customized, which is to say that the audience 32 and event data fields 34 may be defmed by the user with respect to incoming event data, so as to represent a user-defmed consumer and/or other entity action. The journey components 164 may therefore include a custom journey component, which represents one or more such custom events. By way of the system, custom events may be more easily defined and implemented via intuitive graphical user interfaces.

Returning now to FIG. 2, by way of the virtual canvas 162, the journey components 164 can be selected and arranged by the user within the virtual canvas workspace, and their properties altered or otherwise customized by the user. The selection and arrangement can be via drag-and-drop operation, or other interface interaction, from a journey component palate (shown to the right) that provides potential journey components.

The journey design may be stored in the one or more databases such that the build module may retrieve the journey design and generate the corresponding campaign in connection with the implementation of one or more campaigns by the marketing system 10.

Returning to now to FIG. 1A, the message design module 170 generally enables and manages the design of electronic messages by the user, which electronic messages may be sent to customer devices 300 via implementation of one or more campaigns by the computerized marketing system 10. The message design module 170 may cause the GUI module 10 to generate and display the graphical-user-interface to include a virtual message canvas 172 via which one more electronic messages 174 may be designed by the user.

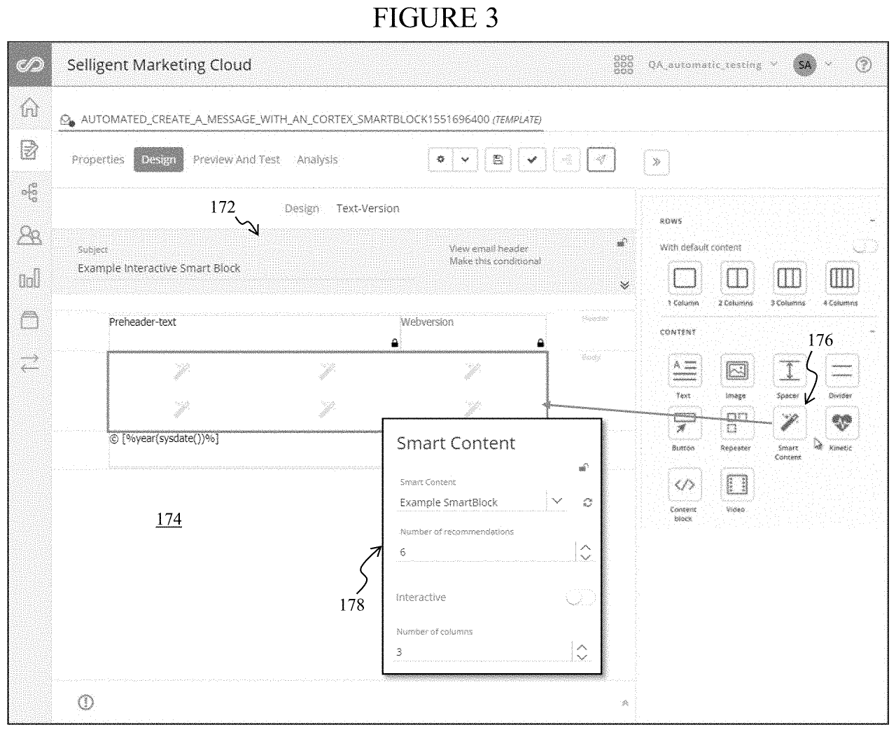

FIG. 3 schematically illustrates an example virtual message canvas 172 via which e-mail electronic messages 174 may be designed by the user. It will be understood that the principles of the invention may be applied to other non-e-mail electronic messages, including but not limited to SMS messages and internet messages.

The virtual message canvas 172 is an interactive graphical-user-interface environment via which the user may plan and define electronic messages 174 through direct user interaction with graphic elements representing various message components 176. Each message component is software code, to be included in the electronic message, that affects the display of the electronic message to the customer.

By way of the virtual message canvas 172, the message components 176 can be selected and arranged by the user within the virtual canvas workspace, and their properties altered or otherwise customized by the user via properties interfaces 178. The selection and arrangement can be via drag-and-drop operation, or other interface interaction, from a journey component palate (shown to the right) that provides potential message components.

The message design may be stored in the one or more databases such that the build module 130 may retrieve the message design and generate the corresponding electronic message 174 in connection with the implementation of one or more campaigns by the marketing system 10.

Returning now to FIG. 1A, the audience module 150 generally enables and manages one or more of a plurality of audience sets linked to the electronic message and/or the campaign by the user. In particular, each electronic message and/or campaign may be associated with an audience set. In at least one aspect, the audience set identifies the electronic message and/or campaign recipients.

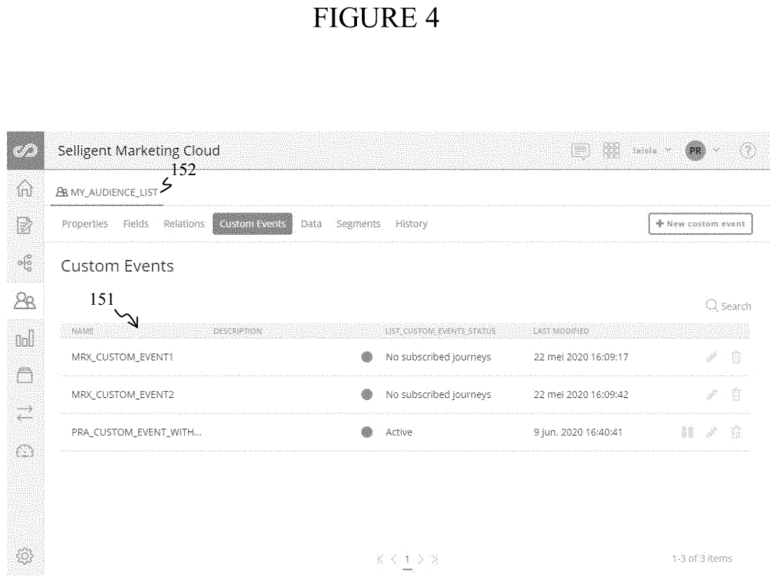

The audience module 150 may be configured to allow the user, via the graphical-user-interface to define a custom event as shown for example in FIGS. 4-7. The custom event may be defined, as discussed with respect to FIG. 1B. It will be understood that the custom events are not limited to credit card expirations, and may include any other type of event conceivably associated with the audience set. The custom event may, for example, represent any consumer and/or other entity action, or action related thereto, and may include any type of event data reasonably related to the custom event. The event data may be stored in the one or more databases 500 and/or may be provided by users and/or third-parties to the system via one or more APIs.

The system 10 may reference the custom event to, for example, generate messages or journeys, as described herein, from the custom event.

For example, the custom event may be the impending expiration of a credit card, which triggers, via an appropriately designed journey component, an electronic message to be sent to the customer notifying the customer of the impending expiration and providing a link where the customer can renew the credit card. The corresponding event data may include, for example, card expiration status, expiration date, card type, card number or last 4 digits, name on card, etc. Thus, via the appropriately arranged journey, the occurrence of the custom event (i.e., detection by the computerized marketing system 10 via the incoming event data) may cause the computerized marking system 10 to generate and send one or more electronic messages, in accordance with the corresponding journey, which message may, via use of the event data, have the following content: “Greetings [name on card]—Your [card type] ending in [last 4 digits] will expire on [expiration date]. Please visit our website at [website] to renew.”

As an additional example, the custom event may be that an online shopping customer has put items in virtual shopping cart followed by a period of inactivity. The corresponding custom event data may include, for example, the product information, the period of inactivity, the online store name, etc. Thus, via the appropriately arranged journey, the occurrence of the custom event (i.e., detection by the computerized marketing system 10 via the incoming event data) may cause the computerized marking system 10 to generate and send one or more electronic messages, in accordance with the corresponding journey, which message may, via use of the event data, have the following content: “Friendly reminder that the following items are in your shopping cart at [online store name]: [product information], [product information]. Please visit [website] to continue shopping.”

As a further example, the custom event may be that a casino patron has played a certain casino game. The corresponding custom event data may include, for example, the game name, the patron name, that the patron played, promotional content, etc. Thus, via the appropriately arranged journey, the occurrence of the custom event (i.e., detection by the computerized marketing system 10 via the incoming event data) may cause the computerized marking system to generate 10 and send one or more electronic messages, in accordance with the corresponding journey, which message may, via use of the event data, have the following content: “Thank you for playing [game name]. Please enjoy [promotional content].”

The one or more custom events can be readily defmed by the user, via the graphical-user-interface. An exemplary graphical-user-interface, via which the user may defme the custom event, is shown in FIGS. 4-7.

The graphical-user-interface includes a window that includes a table of currently defmed custom events 151 associated with an audience list 152. The table includes various field columns providing information regarding the custom events.

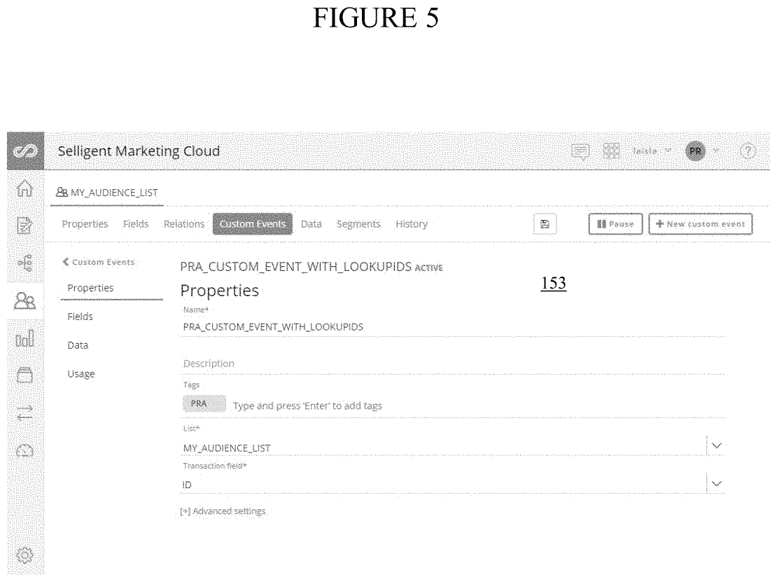

The graphical-user-interface also allows the user to create new custom events, and to edit existing custom events, as shown in FIG. 5. The graphical-user-interface may allow the user to defme the custom event in terms of its properties, fields, data and usage, each having an associated pane or tab 153-156. Defming the custom event may be done via text entry fields, drop-down lists, etc.

The selection of properties tab 153 allows the user to further defme one or more of: the custom event name, description, tags, attached audience list, transaction field, and linked data table. These definitions allow for the custom event to be easily referenced by the user via the graphical user interface.

The selection of the fields tab 154 allows the user to defme one or more of the event data fields for which the custom event data object 30 receives the event data. The user may defme, for example, the field name, type, length, and description. Defming the field type may include a dropdown menu of different field types, e.g., text, Boolean, numeric, long, float, date, datetime, complex, etc., that are selectable by the user. Defming the custom event fields may also include adding one or more new fields to the custom event.

The selection of the data tab 155 allows the user to defme the data that is provided to the various fields of the custom event. The data can be directly inserted, or may be provided via linking to the one or more databases of the system and/or to third party databases via various APIs. The usage tab 156 may identify which journeys and messages the custom event is linked to.

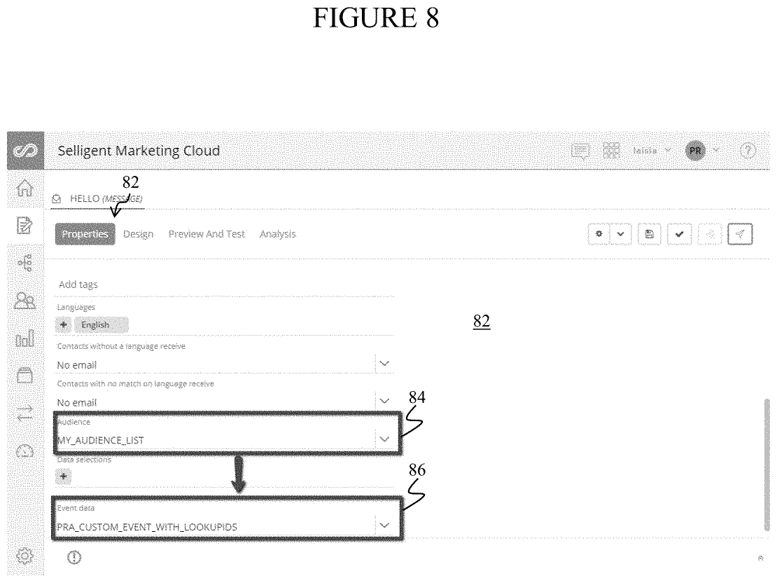

In at least one embodiment, one or more custom events may be used, via the message design module 170, to design electronic messages 174. For example, an electronic message may be designed to be sent to a customer notifying the customer of an impending expiration of a credit card. An exemplary graphical-user-interface, via which the user may design an electronic message using a custom event, is shown in FIGS. 8-10.

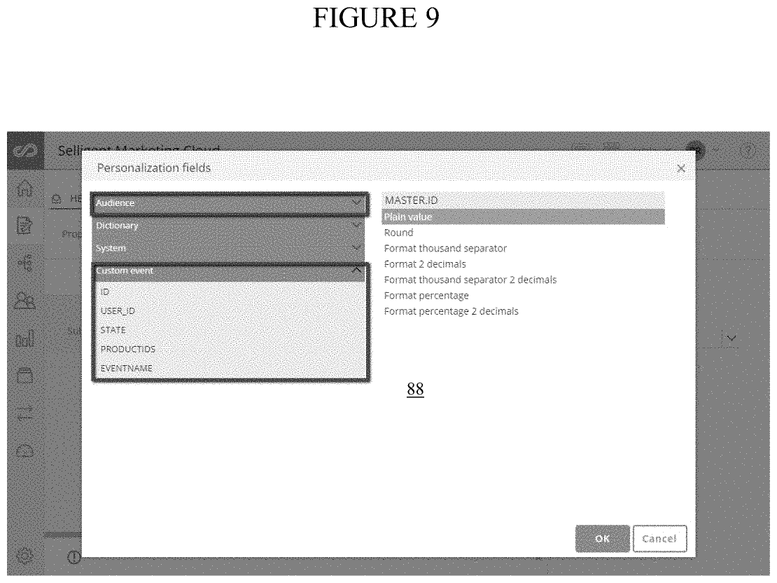

The graphical-user-interface for designing the electronic message may include a message properties tab 82, via which the user may attach the custom event to the electronic message. The message properties tab 82 may allow the user to link the electronic message to an audience list via a drop-down audience field 84. The message properties tab 82 may also allow the user to use the event data of the linked custom event in generating the electronic message, e.g., via a drop-down events field 86 and pop-up window 88. The drop-down events field 86 may list custom events (and other events) linked to the selected audience list 152, as shown in FIG. 9.

As discussed with reference to FIG. 3, the graphical-user-interface for designing the electronic message may further include the message design pane, which provides the virtual message canvas 172 via which the user may design the electronic message 174. The user may insert content via drag-and-drop of a message component icon, which may allow for further defming of the properties of the content. The defming of the message component properties 176 may include adding event data as message content.

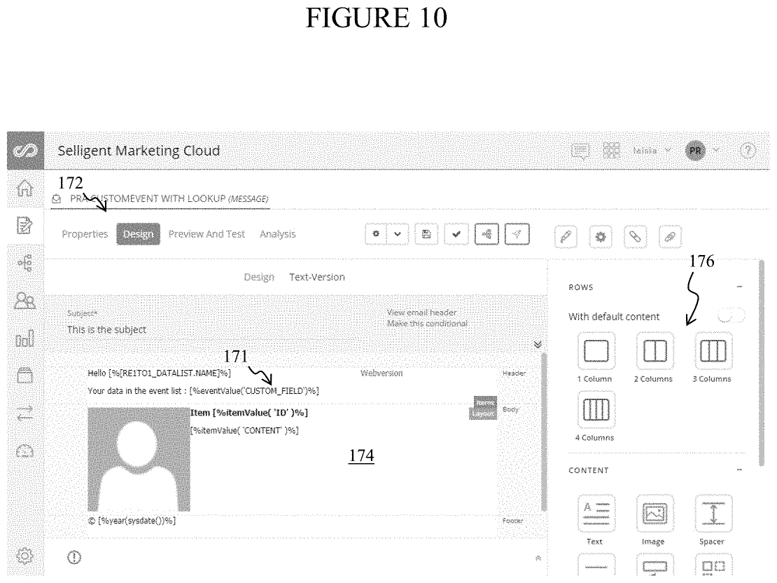

In FIG. 10, for example, a text component has been added to the electronic message, and the properties of the text is shown as from the custom events linked to the email (as identified by 171). Accordingly, an electronic message can be designed that, for example, has the following content defined by custom event data fields: “Greetings [name on card]—Your [card type] ending in [last 4 digits] will expire on [expiration date]. Please visit our website at [website] to renew.” As the custom event fields are linked to the data for the audience, as discussed herein, each of the fields will be populated by appropriate data corresponding to the recipient, thus providing a personalized electronic message.

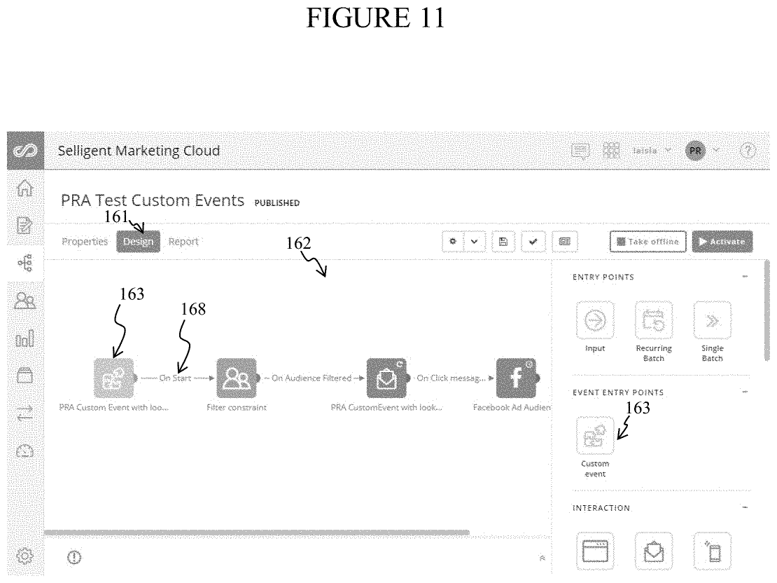

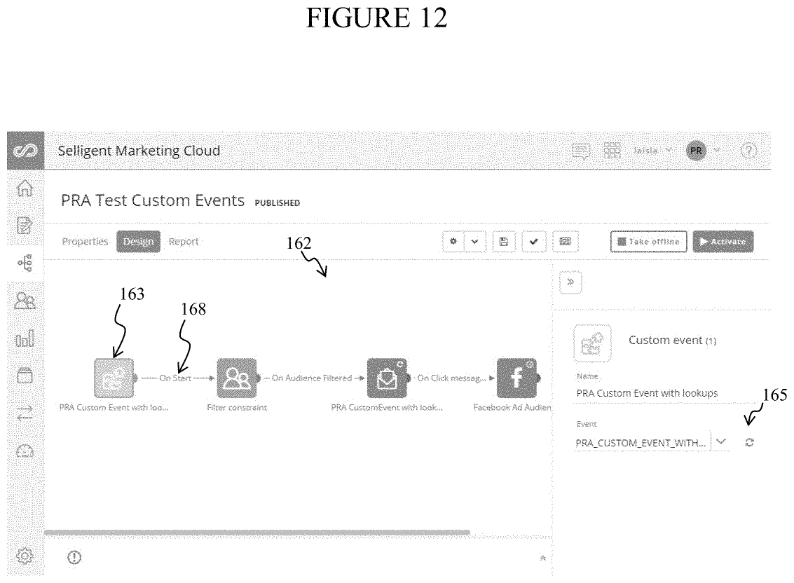

In at least one embodiment, one or more custom events may be used, via the journey design module 160, to design one or more journeys. For example, a journey may be designed to send an electronic message to a customer notifying the customer of an impending expiration of a credit card. An exemplary graphical-user-interface, via which the user may design the journey using a custom event, is shown in FIGS. 11-12.

The graphical-user-interface for designing the journey may include a journey properties tab (not shown) similar to that of the message properties tab 82, via which the user may link the custom event to the journey. The journey properties tab may allow the user to link the journey to an audience list via a drop-down audience field 84. The custom events associated with the linked audience may then be accessible for use by the journey design module in the design of the journey. Such use may include the inclusion of custom journey components, which may include triggers 166 that may be satisfied by custom event data and/or other actions that use the custom event data in some way.

The graphical-user-interface for designing the journey may further include the journey design pane 161, which provides the virtual canvas 162 via which the user may design the journey. As discussed, the user may insert content via drag-and-drop of a journey component icon from a component pane, which may allow for further defming of the properties of the journey component. As discussed, when the custom event is linked to an audience list 152 for which there are also custom events, the journey component pane may include a custom event component 163—which may act as a potential entry point for the journey, as shown in FIG. 11.

When the custom event component is drag-and-drop inserted into the virtual canvas 162 as an entry point for a journey, the graphical-user-interface may further allow the user to define which custom event the custom event component is to refer to. This may occur, for example, via a dropdown menu 165 of a properties pane for the custom event component, as shown in FIG. 12. The dropdown menu 165 may include each custom event linked to the audience of the journey, so that the user may select the appropriate custom event desired for the entry point.

For example, the custom event entry point may be the impending expiration of a credit card. The corresponding custom event data object 30 may then be linked to the sending of an electronic message, in accordance with the operation of the journey design module. Thus, the satisfaction of the custom event (i.e., the event data indicates that the trigger conditions are satisfied) then would trigger, for example, the sending of the electronic message. In at least some embodiments, the electronic message can be created, as discussed herein, using custom event data.

The build module 130 generates campaigns, and aspects thereof, for implementation by the marketing system. The generation of campaigns may include retrieving and compiling software code, instructions, actions and/or operations corresponding to message and/or campaign designs stored in the one or more databases. The generated campaigns are communicated to the marketing system 10 for implementation thereby. The databases 140 generally store the data for use by one or more of the other modules. The platform network 180 is a data communication network that communicatively couples the modules in accordance with their respective functionalities.

The system architecture 20 may also include a computerized marketing module 190, which may be embodied in the computerized marketing system 10, configured to execute the designed campaigns, or aspects thereof.

The embodiments described in detail above are considered novel over the prior art and are considered critical to the operation of at least one aspect of the described systems, methods and/or apparatuses, and to the achievement of the above described objectives. The words used in this specification to describe the instant embodiments are to be understood not only in the sense of their commonly defmed meanings, but to include by special defmition in this specification: structure, material or acts beyond the scope of the commonly defmed meanings. Thus, if an element can be understood in the context of this specification as including more than one meaning, then its use must be understood as being generic to all possible meanings supported by the specification and by the word or words describing the element.

The defmitions of the words or drawing elements described herein are meant to include not only the combination of elements which are literally set forth, but all equivalent structure, material or acts for performing substantially the same function in substantially the same way to obtain substantially the same result. In this sense, it is therefore contemplated that an equivalent substitution of two or more elements may be made for any one of the elements described and its various embodiments or that a single element may be substituted for two or more elements.

Changes from the subject matter as viewed by a person with ordinary skill in the art, now known or later devised, are expressly contemplated as being equivalents within the scope intended and its various embodiments. Therefore, obvious substitutions now or later known to one with ordinary skill in the art are defmed to be within the scope of the defmed elements. This disclosure is thus meant to be understood to include what is specifically illustrated and described above, what is conceptually equivalent, what can be obviously substituted, and also what incorporates the essential ideas.

Furthermore, the functionalities described herein may be implemented via hardware, software, firmware or any combination thereof, unless expressly indicated otherwise. If implemented in software, the functionalities may be stored in a memory as one or more instructions on a computer readable medium, including any available media accessible by a computer that can be used to store desired program code in the form of instructions, data structures or the like. Thus, certain aspects may comprise a computer program product for performing the operations presented herein, such computer program product comprising a computer readable medium having instructions stored thereon, the instructions being executable by one or more processors to perform the operations described herein. It will be appreciated that software or instructions may also be transmitted over a transmission medium as is known in the art. Further, modules and/or other appropriate means for performing the operations described herein may be utilized in implementing the functionalities described herein.

What is claimed is:

1. A marketing campaign design system, comprising:
a graphical user interface configured to enable a user to define a custom event with respect to an audience, wherein the custom event associates the audience with incoming custom event data; and
a journey design module configured to enable the user to design a marketing campaign or portion thereof via drag-and-drop of one or more journey components, wherein the journey components represent actions to be taken by a computerized marketing system in executing the marketing campaign or portion thereof,
wherein the graphical user interface is further configured to enable the user to link the marketing campaign or portion thereof to the audience, so as to activate one or more custom journey components, usable by the user to design the marketing campaign, the custom journey components referencing the custom event data.

2. The marketing campaign design system of claim 1, further comprising:
a message design module configured to enable the user to design an electronic message via drag-and-drop of one or more message components, wherein the message components represent software code to be included in the electronic message that affects the display of the electronic message to its recipient,
wherein the graphical user interface is further configured to enable the user to link the electronic message to the audience, so as to activate the use of the custom event data within one or more message components.

3. The marketing campaign design system of claim 1, wherein the journey design module is further configured to assign one or more respective triggers to the custom journey components, wherein the triggers represent events in response to which the actions represented by the custom journey component are taken.

4. The marketing campaign design system of claim 3, wherein the triggers are assignable to respective custom journey components by the user via drag-and-drop.

5. The marketing campaign design system of claim 3, wherein the triggers are visibly assignable to respective custom journey components by the user.

6. The marketing campaign design system of claim 1, wherein the one or more journey components are visibly arrangeable by the user into a campaign design that is executable by the computerized marketing system, wherein the campaign design includes at least one custom journey component.

7. The marketing campaign design system of claim 6, wherein the at least one custom journey component of the campaign design references custom event data as an entry point for the marketing campaign.

8. The marketing campaign design system of claim 1, wherein the graphical user interface is further configured to enable the user to select a previously defined custom event for use in designing the marketing campaign.

9. The marketing campaign design system of claim 1, wherein the graphical user interface is further configured to enable the user to define the custom event according to one or more of:
properties, fields, data and usage.

10. A marketing campaign design method, comprising:
defming, via a graphical user interface, a custom event with respect to an audience, wherein the custom event associates the audience with incoming custom event data within a computerized marketing campaign design system;
linking, via the graphical user interface, a marketing campaign or portion thereof to the audience, so as to activate one or more custom journey components, usable by the user to design a marketing campaign, the custom journey components referencing the custom event data; and
designing, via the graphical user interface, the marketing campaign or portion thereof via drag-and-drop of one or more journey components, which journey components represent actions to be taken by the computerized marketing system in executing the marketing campaign or portion thereof, wherein the one or more journey components include at least one custom journey component.

11. The method of claim 10, further comprising:
linking, via the graphical user interface, an electronic message to the audience, so as to activate the use of the custom event data within one or more message components; and
designing, via the graphical user interface, an electronic message via drag-and-drop of one or more message components, which message components represent software code to be included in the electronic message that affects the display of the electronic message to its recipient.

12. The method of claim 10, further comprising:
assigning, via the graphical user interface, one or more respective triggers to the custom journey components, wherein the triggers represent events in response to which the actions represented by the custom journey component are taken.

13. The method of claim 12, wherein the triggers are assignable to respective custom journey components by the user via drag-and-drop.

14. The method of claim 12, wherein the triggers are visibly assignable to respective custom journey components by the user.

15. The method of claim 10, wherein the one or more journey components are visibly arrangeable by the user into a campaign design that is executable by the computerized marketing system, wherein the campaign design includes at least one custom journey component.

16. The method of claim 15, wherein the at least one custom journey component of the campaign design references custom event data as an entry point for the marketing campaign.

17. The method of claim 10, further comprising:
selecting, via the graphical user interface, a previously defined custom event for use in designing the marketing campaign.

18. The method of claim 10, further comprising:
defining, via the graphical user interface, the custom event according to one or more of: properties, fields, data and usage.
